(19) United States
(12) Patent Application Publication
(10) Pub. No.: US 2017/0316365 A1
(43) Pub. Date: Nov. 2, 2017

(54) ESTIMATION DEVICE, ESTIMATION METHOD, AND ESTIMATION PROGRAM

(71) Applicant: FUJITSU LIMITED, Kawasaki-shi (JP)

(72) Inventor: Akira KARASUDANI, Yamato (JP)

(73) Assignee: FUJITSU LIMITED, Kawasaki-shi (JP)

(21) Appl. No.: 15/463,285

(22) Filed: Mar. 20, 2017

(30) Foreign Application Priority Data
Apr. 28, 2016 (JP) 2016-091475

(51) Int. Cl. G06Q 10/06; G06Q 50/22

(52) U.S. Cl. CPC G06Q 10/06398; G06Q 10/063114; G06Q 50/22

(57) ABSTRACT

An estimation method causing a computer to execute a process, the process includes: extracting at least one event that occurs with respect to a work target in a time period from first performance of specific work to second performance of the specific work performed after the first performance, out of the plurality of events which includes at least one session of the specific work performed for the work target, stored in a storage unit that associates the plurality of events with date and times in which the plurality of events occurred respectively; and estimating service provision time of the specific work at the time of the second performance, based on the at least one event.

### CROSS-REFERENCE TO RELATED APPLICATION

This application is based upon and claims the benefit of priority of the prior Japanese Patent Application 2016-091475, filed on Apr. 28, 2016, the entire contents of which are incorporated herein by reference.

### FIELD

The embodiments discussed herein are related to an estimation device, an estimation method, and an estimation program.

### BACKGROUND

For example, there is a case in which an operator provides service in in-home medical care, at-home nursing, or the like, by visiting a work target at home who receives a service. The work target may be, for example, a patient, a person requiring long-term care, or the like. For example, in the in-home medical care, a visiting doctor and a visiting nurse visit patients at home and provide visiting medical service and nursing. In the at-home nursing, a caregiver visits a person requiring long-term care at home and provides a nursing care. In this case, the operator may visit the work target, for example, a multiple number of times, and perform the work on a continuing basis. Then, in planning a work schedule and the like, service provision time is estimated by the operator based on the operator's experience.

In this regard, a technology is known by which an efficient repair work sequence is planned (for example, Japanese Laid-open Patent Publication No. 2006-227751). In addition, a technology is known by which makes identification of a problem area easier, and makes the significance of work improvement is clear by quantitatively evaluating the effect of improved work process (for example, Japanese Laid-open Patent Publication No. 2006-260156).

As described above, for example, there is a case in which a certain type of work is continuously performed for a work target over a multiple number of times. In this case, for example, it is presumed that it takes about the same amount of time to perform the work if the condition of the work target does not widely change. However, when some kind of change in condition occurs after the work was performed on the work target last time, kind of service to be provided when the work is performed next time may change. In this case, for example, while the operator attempts to estimate service provision time for making a plan for the work, the accuracy of the estimated service provision time may be reduced due to a change in the kind of service. An object of an embodiment is to estimate service provision time for work with high accuracy.

### SUMMARY

According to an aspect of the invention, an estimation method causing a computer to execute a process, the process includes: extracting at least one event that occurs with respect to a work target in a time period from first performance of specific work to second performance of the specific work performed after the first performance, out of the plurality of events which includes at least one session of the specific work performed for the work target, stored in a storage unit that associates the plurality of events with date and times in which the plurality of events occurred respectively; and estimating service provision time of the specific work at the time of the second performance, based on the at least one event.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a timeline of a multiple number of events that have occurred in a certain work target;

FIG. 2 is a diagram illustrating an example of an estimation system according to an embodiment;

FIG. 3 is a diagram illustrating an example of a functional block configuration of an estimation device according to the embodiment;

FIG. 4 is a diagram illustrating event information according to the embodiment;

FIG. 5 is a flowchart illustrating processing to set standard service provision time, which is executed by a control unit of the estimation device in the embodiment;

FIG. 6 is a diagram illustrating an example of standard service provision time information;

FIG. 7 is a flowchart illustrating an example of an operational flow of processing to extract a related event in the embodiment;

FIG. 8 is a diagram illustrating an example of related event information according to the embodiment;

FIG. 9 is a flowchart illustrating an example of difference time analysis processing in the embodiment;

FIG. 10 is a diagram illustrating an example of related event difference time information;

FIG. 11 is a diagram illustrating an example of an equation of regression analysis;

FIG. 12 is a diagram illustrating an example of coefficient information according to the embodiment;

FIG. 13 is a diagram illustrating an example of request information;

FIG. 14 is a flowchart illustrating an example of service provision time estimation processing in the embodiment; and

FIG. 15 is a diagram illustrating an example of a hardware configuration of a computer for implementing the estimation device according to the embodiment.

### DESCRIPTION OF EMBODIMENTS

Some of the embodiments of the technology discussed herein are described below in detail with reference to drawings. The same symbol is assigned to corresponding elements in different drawings. In the following description, visiting medical service and the like in in-home medical care are described as examples of work, but the embodiments are not limited thereto. The work may also be, for example, another work such as visiting nursing service and the like in at-home nursing. In addition, for example, in the same visiting medical service work, kind of service may be varied. For example, in one visiting medical service, a physician's history taking and blood pressure measurement may be performed, and in another visiting medical service, blood collection may be performed in addition to a physician's history taking and blood pressure measurement. In addition, the description below refers to a patient as an example of a work target. However, the embodiments are not limited to such an example. A work target may include, for example, a patient, a person requiring long-term care, and other targets, as long as such person is a target to receive service by the operator.

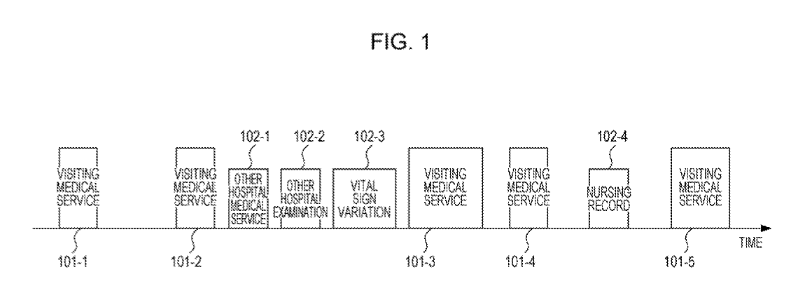

FIG. 1 is a diagram illustrating an example of a timeline of a multiple number of events that have occurred in a certain work target. In FIG. 1, work of visiting medical service 101 is continuously performed on the work target over a multiple number of times (101-1 to 101-5). Here, for example, if the condition of the work target has not changed significantly, service provided in the work will not change, and it is presumed that the service provision time of the visiting medical service 101 will stay almost the same. For example, In FIG. 1, the service provision time for the visiting medical service 101-1, the visiting medical service 101-2, and the visiting medical service 101-4 are almost the same. However, for example, when some kind of change occurs in the work target, service different from the usual service may be provided, and the service provision time may change. In addition, any change that has occurred in the work target may emerge as an event related to the work target. For example, let us assume that a change occurs in which the work target catches a cold. An event like the work target going to the hospital or buying medicines in a pharmacy may arise in such a case. Hereinafter, such an event related to the work target is referred to as a related event 102.

Thus, when a related event 102 occurs, the operator may perform a service different from the usual service, and as a result, medical service time may change. For example, in FIG. 1, in a time period between the visiting medical service 101-2 and the visiting medical service 101-3, related events 102-1 and 102-2 that indicate that the work target received medical service in other hospitals and a related event 102-3 of vital sign fluctuation indicating that there was a change in the vital signs, occurred. Then, in the visiting medical service 101-3, for example, the operator performed a service different from the usual service in order to observe history of changes in the condition which occurred in the work target, and as a result, the medical service time was extended. Similarly, in a time period between the visiting medical service 101-4 and the visiting medical service 101-5, a related event 102-4 occurred which is a nursing record to indicate that the work target received nursing service. As a result, in the visiting medical service 101-5, the operator performed a service different from the usual service, and the medical service time was extended.

In this manner, for example, when the related event 102 occurred in the work target, service to be performed in the next work may change, and as a result, the service provision time may change. In this case, while the operator attempts to estimate service provision time for making a plan for the work, the accuracy of the estimated service provision time may be reduced. Thus, as a result of the reduced estimation accuracy of the service provision time, for example, although only five requests for work may be accepted, a schedule for more work may be planned. Conversely, for example, while it is actually possible to perform work for 10 requests, a schedule may be planned in which work for only eight requests is to be performed. A technology is therefore desired by which service provision time for work may be estimated with high accuracy.

In an embodiment described below, for example, when service provision time is estimated, it is determined whether or not a related event 102 has occurred in a work target in a time period between the work to be estimated and the same type of work immediately preceding the work being estimated. Then, if the related event 102 has occurred, service provision time for the work to be estimated will be estimated based on the related event 102. Accuracy of estimating service provision time may be thereby improved. This thereby enables, for example, number of requests for work and the like performed in a day to be set appropriately, and opportunity loss of work to be reduced. In addition, for example, accuracy of determining whether or not a sudden work request for an emergency patient or the like may be accepted may also be improved, enabling a work request to be accepted with confidence. The embodiments are described below with reference to drawings.

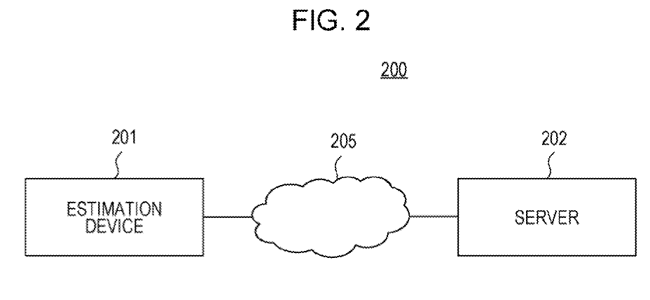

FIG. 2 is a diagram illustrating an example of an estimation system 200 according to an embodiment. The estimation system 200 includes, for example, an estimation device 201 and a server 202. The estimation device 201 and the server 202 may communicate with each other, for example, through a network 205. The estimation device 201 may be, for example, a computer such as a personal computer (PC), a laptop PC, or a tablet terminal. The server 202 may be, for example, a server in which information on a work target in a predetermined area is registered. For example, in regional medical care, there is a regional medical network that stores work records (for example, date and time, type of work, and description) of medical service, examination, nursing, and the like performed on patients in a multiple number of medical institutions, and to be shared by the medical institutions and visiting nurse stations. As an example, the server 202 may be, for example, a server that provides information in the regional medical care network. Alternatively, the server 202 may be a server that provides information associated with information capable of uniquely identifying a work target, such as “My number” (personal identifier (ID) similar to Social Security Number), an identifier for medical care, or the like. The estimation device 201 may obtain information from the multiple number of servers 202. The estimation device 201 may estimate service provision time for work to be performed for a work target, for example, based on information on the work target obtained from the server 202.

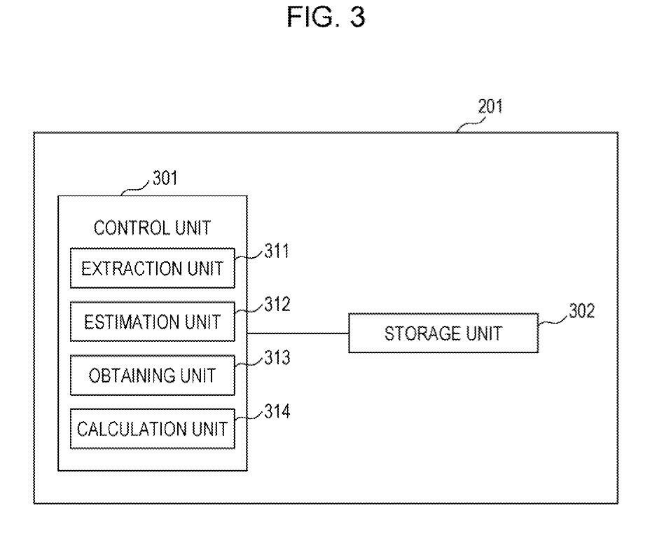

FIG. 3 is a diagram illustrating an example of a functional block configuration of the estimation device 201 according to the embodiment. The estimation device 201 includes, for example, a control unit 301 and a storage unit 302. The control unit 301 includes, for example, an extraction unit 311, an estimation unit 312, an obtaining unit 313, and a calculation unit 314. The storage unit 302 may store, for example, information such as event information 400, standard service provision time information 600, related event information 800, related event difference time information 1000, coefficient information 1200, and request information 1300, that are described later. These units and the information stored in the storage unit 302 are described later in detail.

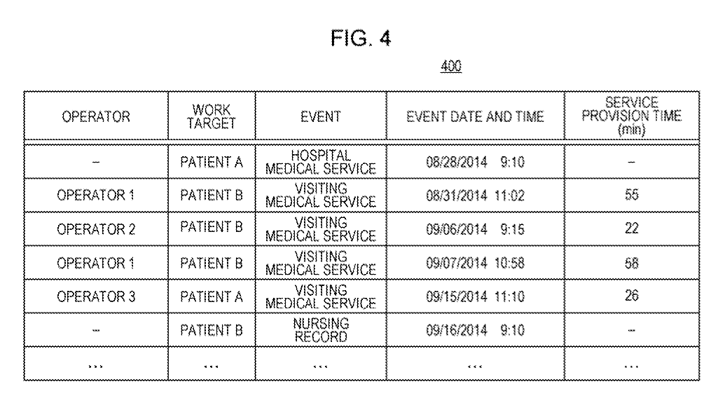

FIG. 4 is a diagram illustrating the event information 400 according to the embodiment. In the event information 400, information on an event that has occurred in a work target is registered as an entry. In the event information 400, for example, entries corresponding to related events that have occurred in the work target such as medical service in other hospitals and nursing service record, and an entry related to work such as visiting medical service continuously performed on the work target over a multiple number of times are registered. In the event information 400, each of the entries includes information such as “operator”, “work target”, “event”, “event date and time”, and “service provision time”. The “operator” is, for example, information used to identify an operator who has performed work when the entry is related to the work. When the entry corresponds to a related event (service in other hospitals, nursing service record, and the like), a value does not have to be registered in the “operator”. The “work target” is information used to identify a target for whom an event corresponding to the entry has occurred. The “event” is information used to identify the event that has occurred in the work target corresponding to the entry. Even for the same event (for example, visiting medical service), actual service varies more or less for each different work target, so that the detail of the event may be distinguished by the work target information. The “event date and time” may be, for example, a date and time in which the event corresponding to the entry occurred. The “service provision time” may be time taken for the work corresponding to the entry when the entry is an entry related to the work. When the entry is an entry corresponding to the related event, a value does not have to be registered in the “service provision time”.

In the example of FIG. 4, the entries are arranged in ascending/descending order of the date and time in which the event occurred (data lower in the order has a later date and time). However, the embodiment is not limited thereto, and for example, in another embodiment, the entries may be registered in order in which data higher in the order has a later date and time. In addition, information on the entries of the event information 400 may be obtained, for example, from the server 202. The control unit 301 of the estimation device 201 may obtain information on the entries of the event information 400 from the multiple number of servers 202.

In an example, when an ID card of the work target is read by a terminal at the time of occurrence of an event, the terminal notifies the information to the server 202, and information on an entry may be registered in the server 202. In this case, for example, the event date and time may be the time at which the ID card of the work target was read by the terminal. In addition, the service provision time may be, for example, time from the time at which the operator caused the terminal to read the ID card at the start of the work to the time at which the operator caused the terminal to read the ID card at the end of the work.

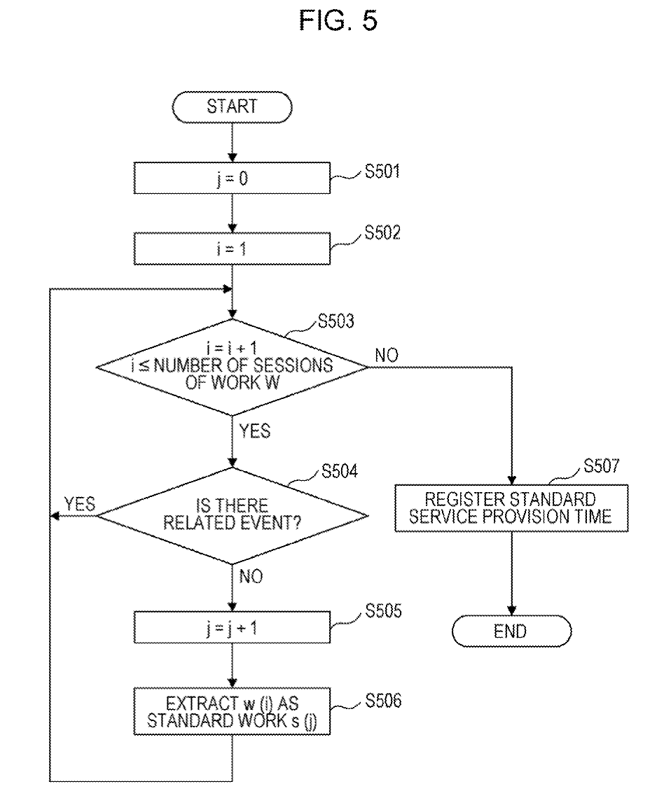

FIG. 5 is a diagram illustrating processing to set standard service provision time for standard work, which is executed by the control unit 301 of the estimation device 201 according to the embodiment. The standard work may, for example, refer to a certain type of work when the work has been continuously performed for the work target over a multiple number of times, and for which a related event 102 has not occurred in the work target in a time period between such work and another work immediately preceding such work. The standard service provision time may indicate service provision time estimated for performing standard work. In addition, when an instruction to execute processing for obtaining standard service provision time is input, for example, the control unit 301 of the estimation device 201 may start the operational flow of FIG. 5 for the certain type of work performed for the certain work target specified by the user.

In Step 501 (hereinafter, Step is represented by “S”, and for example, Step 501 is referred to as S501), for example, the control unit 301 sets the value of a variable j at “0”, and initializes the variable j. In FIG. 5, the variable j is, for example, a variable used for counting the number of standard work entries. In S502, for example, the control unit 301 sets the value of a variable i at “1”, and initializes the variable i. The variable i is, for example, a variable used for counting the number of entries of certain type of work that has been performed for a certain work target, out of entries registered in the event information 400.

In S503, the control unit 301 adds 1 to the variable i, updates the value of the variable i, and determines whether or not the updated variable i is the number of sessions of work W or less. The control unit 301 may obtain the number of sessions of work W, for example, by counting entries in each of which a work target is the certain work target and an event is the certain type of work, out of the entries registered in the event information 400. Hereinafter, an entry in which a work target is the certain work target, and an event is the certain type of work out of the entries of the event information 400 may be referred to as an entry of the certain type of work performed for the certain work target or an entry of the certain type of work for the certain work target. Then, in the processing of S503, for example, the control unit 301 determines whether or not there is an unprocessed entry out of the entries of the certain type of work performed for the certain work target, which are registered in the event information 400. When the variable i is the number of sessions of work W or less (YES in S503), the flow proceeds to S504.

In S504, the control unit 301 determines whether or not there is an entry of a related event 102 for the certain work target in a time period between an entry of a certain type of work w (i-1) and an entry of the certain type of work w (i) that are performed for the certain work target, with reference to the event information 400. For example, entries of the event information 400 may be arranged in ascending/descending order (data lower in the order has a later date and time), and the control unit 301 may assign the value of the variable i, in order from 1, to entries of the certain type of work for the certain work target starting from the entries having an older date and time. Then, the entry of the certain type of work w (i-1) indicates an entry of the i-1th certain type of work out of the sessions of certain type of work for the certain work target registered in the event information 400, and the entry of the certain type of work w (i) may indicate an entry of the i-th certain type of work.

When there is an entry of a related event 102 for the certain work target in the time period between the entry of the certain type of work w (i-1) and the entry of the certain type of work w (i) for the certain work target (YES in S504), the flow returns to S503. On the other hand, when there is no entry of the related event 102 in the time period between the entry of the certain type of work w (i-1) and the entry of the certain type of work w (i) for the certain work target (NO in S504), the flow proceeds to S505. In this case, the entry of the certain type of work w (i) becomes, for example, an entry of standard work.

In S505, the control unit 301 adds 1 to the variable j and updates the value of the variable j. As described above, in FIG. 5, the variable j is, for example, a variable for counting the number of sessions of standard work in each of which the related event 102 has not occurred in a time period from the certain type of work that is the immediately preceding such certain type of work. In S506, the control unit 301 extracts information on an entry of the event information 400, which corresponds to the certain type of work w (i) as the standard work s (j), and the flow returns to S503.

In addition, in S503, when the variable i is not the number of sessions of work W or less (NO in S503), and the control unit 301 has executed processing for all entries of the certain type of work for the certain work target, which are registered in the event information 400, the flow proceeds to S507. In S507, the control unit 301 obtains a representative value representing service provision time of the standard work, from the respective service provision time of the extracted standard work s (j), and registers the representative value in the standard service provision time information 600. For example, the control unit 301 may calculate an average value that has been obtained by averaging the service provision time of each of the sessions of standard work (j), as the representative value. The representative value is not limited to the average value, and for example, may be another statistical value such as a maximum value, a minimum value, a median value, or a mode value. Then, the control unit 301 registers an entry including the certain work target, the certain type of work, and the obtained representative value in the standard service provision time information 600, and the operational flow ends.

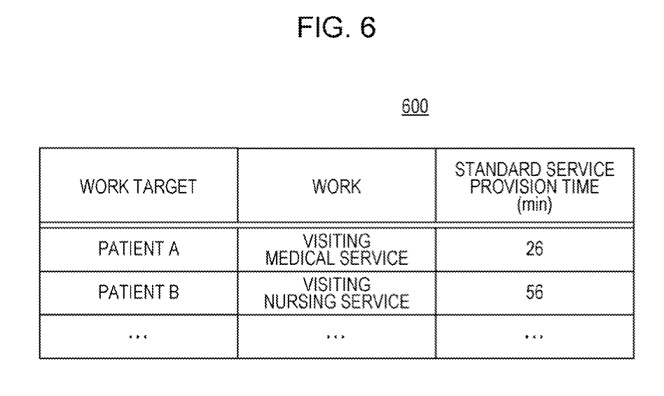

FIG. 6 is a diagram illustrating an example of the standard service provision time information 600. The entry of the standard service provision time information 600 includes, for example, “work target”, “work”, and “standard service provision time”. The “work target” is, for example, information indicating a work target who receives work corresponding to the entry. In addition, the “work” is, for example, information indicating the work corresponding to the entry. Note that the “work target” and the “work” of the standard service provision time information 600 may be, for example, information that respectively corresponds to the “work target” and the “work” registered in the “event” of the event information 400. The standard service provision time may be, for example, a representative value representing service provision time related to performance of the work of the entry, which has been calculated in S507. The standard service provision time information 600 may be stored, for example, in the storage unit 302.

As described above, the control unit 301 is able to estimate, for example, standard service provision time of the standard work through the operational flow of FIG. 5.

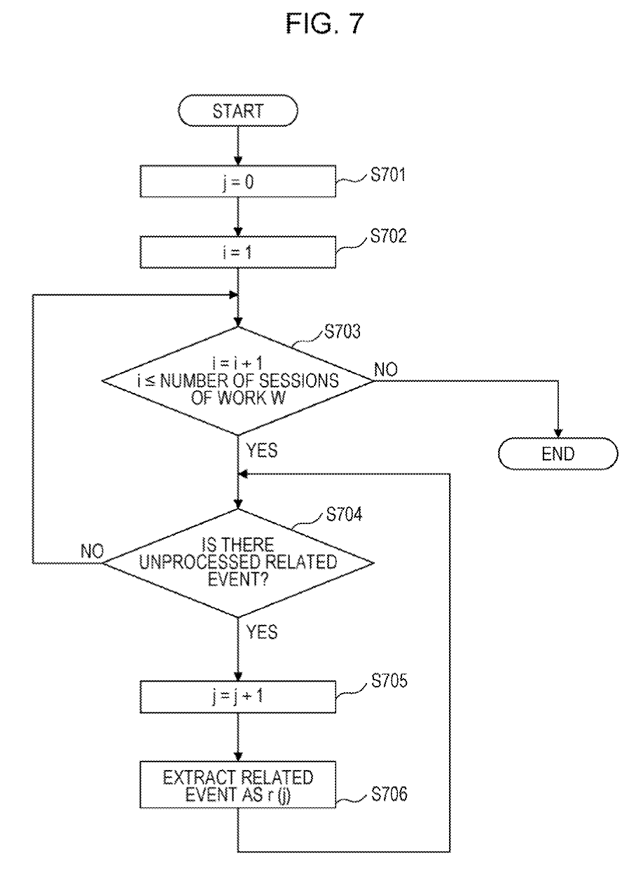

Extraction of an entry of a related event 102 from the event information 400 is next described below. FIG. 7 is a diagram illustrating an example of an operational flow of processing to extract a related event 102 in the embodiment. For example, when an instruction to execute processing to extract a related event 102 is input, the control unit 301 starts the processing to extract a related event 102 of FIG. 7 with respect to a certain type of work in a certain work target that has been specified by the user.

In S701, for example, the control unit 301 sets the value of the variable j at “0”, and initializes the variable j. In FIG. 7, the variable j may be a variable used for counting the number of entries of related events 102 that have occurred in the certain work target in a time period between a multiple number of sessions of certain type of work performed for the certain work target out of the entries of the event information 400.

In S702, the control unit 301 sets the variable i at “1”. The variable i is, for example, a variable used for counting the number of entries of the sessions of certain type of work for the certain work target, which are registered in the event information 400.

In S703, the control unit 301 adds 1 to the variable i, updates the value of the variable i, and determines whether or not the updated variable i is the number of sessions of work W or less. The control unit 301 may obtain the number of sessions of work W, for example, by counting the number of entries in each of which a work target is the certain work target, and an event is the certain type of work out of the entries registered in the event information 400. When the variable i is the number of sessions of work W or less (YES in S703), the flow proceeds to S704.

In S704, the control unit 301 determines whether or not there is an unprocessed entry of a related event 102 for the certain work target in a time period between an entry of the certain type of work w (i-1) and an entry of the certain type of work w (i) that are performed for the certain work target, with reference to the event information 400. For example, the entries of the event information 400 may be arranged in ascending/descending order (data lower in the order has a later date and time), and the control unit 301 may assign the value of the variable i, in order from 1, to entries of the certain type of work for the certain work target starting from the entries having an older date and time. Then, the entry of the certain type of work w (i-1) indicates an entry of the i-1-th certain type of work out of the sessions of certain type of work for the certain work target registered in the event information 400, and the entry of the certain type of work w (i) may indicate an entry of the i-th certain type of work.

When there is no unprocessed entry of a related event 102 for the certain work target in the time period between the entry of the certain type of work w (i-1) and the entry of the certain type of work w (i) for the certain work target (NO in S704), the flow returns to S703. In contrast, when there is an unprocessed entry of a related event 102 for the certain work target in the time period between the entry of the certain type of work w (i-1) and the entry of the certain type of work w (i) for the certain work target (YES in S704), the flow proceeds to S705.

In S705, the control unit 301 adds 1 to the variable j and updates the value of the variable j. As described above, in FIG. 7, the variable j is a variable for counting the number of entries of related events 102 that have occurred in the certain work target in a time period between the certain type of work and another such certain type of work performed immediately preceding such certain type of work. In S706, the control unit 301 extracts a single related event 102 that exists in the time period between the certain type of work w (i-1) and the certain type of work w (i) in order of older data each time the processing of S706 is executed. In addition, each time the related event 102 is extracted in

S706, the control unit 301 may assign the value of the variable j to the related event 102. The control unit 301 extracts information on an entry corresponding to the j-th related event 102 from the event information 400 as a related event r (j) and registers the information in the related event information 800 corresponding to the certain type of work performed for the certain work target, and the flow returns to S704. In addition, in S703, when the variable i is not the number of sessions of work W or less (NO in S703), the operational flow ends.

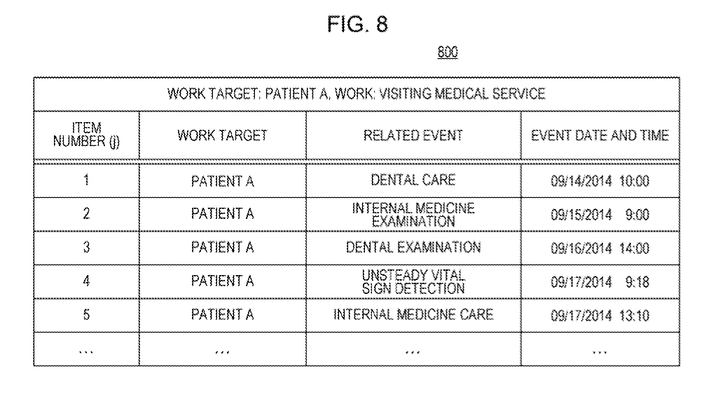

FIG. 8 is a diagram illustrating an example of the related event information 800 generated for a type of work (visiting medical service) for a work target (patient A). The related event information 800 includes, for example, “item number”, “work target”, “related event”, and “event date and time”. The “item number” corresponds to “j” of the related event r (j), and in the related event information 800, for example, the related event r (j) that has been extracted in S706 of the operational flow of FIG. 7 is registered as an entry. In addition, the “work target”, the “related event”, and the “event date and time” of FIG. 8 are respectively information corresponding to the work target, the related event, and the event date and time of the event information 400. The related event information 800 of FIG. 8 is generated, for example, for each of the sessions of certain type of work that have been performed for the certain work target, and may be stored in the storage unit 302. In addition, in the example of FIG. 8, the entries are arranged in ascending/descending order of the event date and times (data lower in the order has a later date and time). However, the embodiments are not limited to such an example. For example, in another embodiment, the entries may be registered in the related event information 800 in order in which data higher in the order has a later date and time.

As described above, for example, the control unit 301 is able to extract a related event 102 for a certain work target, which has occurred between a multiple number of sessions of certain type of work performed for the certain work target, to the related event information 800, according to the operational flow of FIG. 7.

In the operational flow of FIG. 7, the control unit 301 operates, for example, as the obtaining unit 313.

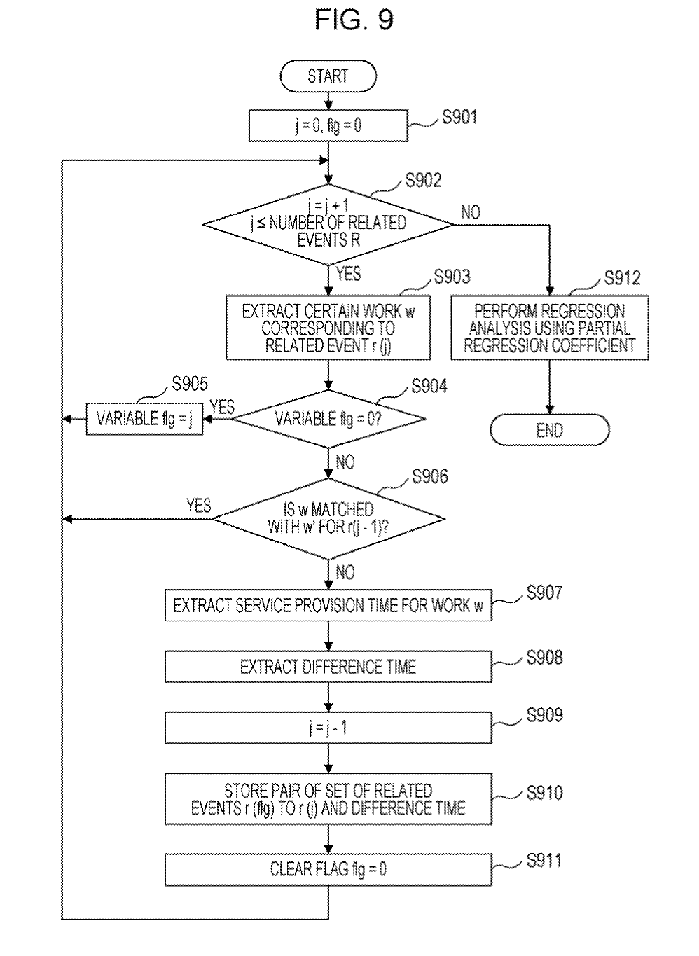

Analysis processing of a difference time between standard service provision time and service provision time for work when a related event 102 has occurred is next described below. FIG. 9 is a diagram illustrating an example of difference time analysis processing in the embodiment. For example, when an execution instruction of the difference time analysis processing is input, the control unit 301 may start the difference time analysis processing of FIG. 9 for a certain type of work performed for a certain work target specified by the user.

In S901, for example, the control unit 301 sets the values of the variable j and the variable flg at “0”, and initializes the variable j and the variable flg. In FIG. 9, the variable j may be a value indicating an item number that has been assigned to the related event r (j) of the related event information 800. The variable flg is described later. In S902, the control unit 301 adds 1 to the value of the variable j, updates the value of the variable j, and determines whether or not the value of the variable j is the number of related events R or less. For example, the control unit 301 may obtain the total number of entries registered in the related event information 800 for the certain type of work performed for the certain work target, as the number of related events R. When the value of the variable j is the number of related events R or less (YES in S902), the flow proceeds to S903.

In S903, for example, the control unit 301 extracts work w corresponding to the related event r (j). For example, the control unit 301 obtains an event date and time of the related event r (j) from the related event information 800. In addition, the control unit 301 may extract a certain type of work for the certain work target, which has been performed immediately after the event date and time of the related event r (j), from the event information 400 as the certain type of work w.

In S904, the control unit 301 determines whether or not the value of the variable flg is 0. When the value of the variable flg is 0 (YES in S904), the flow proceeds to S905. In S905, the control unit 301 sets the value of the variable flg as “j”. The variable flg is, for example, a flag indicating that a set of related events 102 that have occurred before the certain type of work w is being extracted. For example, that the value of the variable flg is 0 may indicate that a set of related events 102 is not being extracted, and that the value of the variable flg is “j” may indicate that the a set of related events 102 is being extracted. In S905, when the control unit 301 sets the value of the variable flg as “j”, the flow returns to S902.

In addition, in S904, when the value of the variable flg is not 0 (NO in S904), the flow proceeds to S906. In S906, the control unit 301 determines whether or not the certain type of work w that has been extracted for the related event r (j) in S903 of the current loop from S902 to S906 is matched with a certain type of work w′ that has been extracted for the related event r (j-1) in S903 of the previous loop. When the respective sessions of work match, it indicates that the related event r (j) and the related event r (j-1) are included in the set of related events 102 generated in a time period between the performance of the certain type of work w for the certain work target extracted in S903, and the immediately preceding performance of the certain type of work for the certain work target.

In S906, when the certain type of work w with respect to the related event r (j) is matched with the certain type of work w′ with respect to the previous related event r (j-1) (YES in S906), the flow returns to S902. On the other hand, when the certain type of work w with respect to the related event r (j) does not match with the certain type of work w′ with respect to the previous related event r (j-1) (NO in S906), the flow proceeds to S907.

In S907, the control unit 301 extracts the service provision time of the certain type of work w from the “service provision time” of the event information 400. In S908, the control unit 301 extracts a difference between the extracted service provision time of the certain type of work w and the standard service provision time associated with the certain type of work w in the standard service provision time information 600. In S909, the control unit 301 subtracts 1 from the value of j. In S910, the control unit 301 stores, for example, an entry including a pair of the set of related events from the related event r (fig) to the related event r (j) and the difference time in the related event difference time information 1000. Note that, for example, “flg=j” is set in S905, and the value of fig is the value of j at the start of extraction of the set of related events 102. Therefore, the set of related events from the related event r (fig) to the related event r (j) is a set of related events 102 for the certain work target, which have occurred in a time period between the performance of the certain type of work w for the certain work target between the previous performance of the certain type of work for the certain work target.

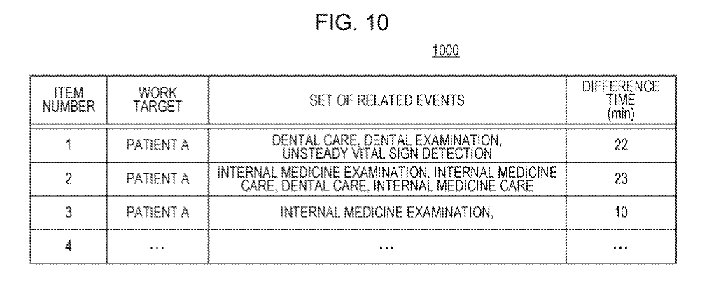

FIG. 10 is a diagram illustrating an example of the related event difference time information 1000. The related event difference time information 1000 includes, for example, “item number”, “work target”, “set of related events”, and “difference time”. The “item number” is a number assigned to an entry of the related event difference time information 1000. In addition, the “work target” may be a certain work target that has been specified at the time of input of an execution instruction of the difference time analysis processing. The “set of related events” and the “difference time” of the related event difference time information 1000 may be the “set of related events” and the “difference time” that have been obtained as a pair in S910 of FIG. 9. The “set of related events” is the set of related events 102 that have occurred in the time period between the performances of the corresponding certain type of work w and the previous performance of the certain type of work. In addition, the “difference time” is time indicating a deviation from the standard service provision time of the certain type of work w, which has occurred due to the set of related events registered in the entry. For example, in the entry of the item number 1 of FIG. 10, it is indicated that the service provision time is extended by 22 minutes due to a set of related events “dental care, dental examination, and unsteady vital sign detection” that have occurred in a certain work target “patient A”.

Subsequently, in S911 of the operational flow of FIG. 9, the control unit 301 sets the variable flg at the value “0”, and the flow returns to S902. Note that the value “0” of the variable flg indicates that the set of related events 102 is not being extracted.

In addition, in S902, when the value of the variable j is not the number of related events R or less (NO in S902) after 1 has been added to the variable j and the variable has been updated, the flow proceeds to S912. In S912, the control unit 301 performs regression analysis using a pair of set of related events and the difference time registered in each of the entries registered in the related event difference time information 1000.

When the regression analysis is performed, a related event 102 assigned to a partial regression coefficient used for the regression analysis may be set arbitrarily as long as the related event 102 is not correlative with and is independent of the influence on the service provision time. In addition, the number of partial regression coefficients may be set arbitrarily. For example, a coefficient may be assigned to each of the related events 102 registered in the “related event” of the related event information 800. In addition, for example, a coefficient does not have to be assigned to a related event that has a low probability to affect the service provision time out of the related events 102 registered in the related event information 800. Alternatively, a single coefficient may be assigned to some of related events 102 similar to each other. The number of partial regression coefficients may be set, for example, according to the processing speed of a computer used for the regression analysis and the estimation accuracy of the service provision time and the like, desired depending on a usage situation of the embodiment.

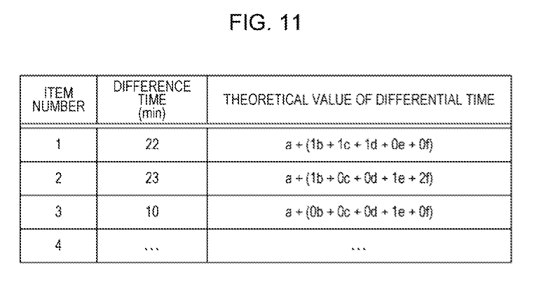

FIG. 11 is a diagram illustrating an example of an equation of regression analysis. For example, it is assumed that partial regression coefficients are a to f. In this case, for example, it is assumed that the coefficient a is a Y intercept of the regression analysis. In addition, for example, it is assumed that dental care of the related event information 800 is assigned to the coefficient b, dental examination is assigned to the coefficient c, unsteady vital sign detection is assigned to the coefficient d, internal medicine examination is assigned to the coefficient e, and internal medicine care is assigned to the coefficient f. In this case, the control unit 301 may generate an equation of the regression analysis from the related event difference time information 1000.

In the equation of the regression analysis illustrated in “theoretical value of the difference time” of FIG. 11, a number assigned to each of the coefficients a to f indicates occurrence frequency of a related event 102 corresponding to the coefficient. For example, in the item number 2 of FIG. 11, an equation of the “difference time 23 minutes=a+(1b+0c+0d+1e+2f)” is generated. Such an equation corresponds to an entry of the item number 2 of the related event difference time information 1000, and a number related to the coefficient f assigned to “internal medicine care becomes 2 because the internal medicine care occurs twice. Similarly, a number related to the coefficient e that has been assigned to the “internal medicine examination” becomes 1, and a number related to the coefficient b that has been assigned to the dental care becomes 1, the numbers related to the other coefficients become 0 (excluding “a”). In addition, an equation may be similarly generated for other entries of the related event difference time information 1000.

In addition, for example, the control unit 301 may determine values of the coefficients a to f by performing the regression analysis using a multiple number of equations of regression analysis, which have been generated from FIG. 11. The control unit 301 may obtain a partial regression coefficient, for example, by multiple regression analysis so that a sum of squares of a difference between the difference time of FIG. 11 and a theoretical value of the difference time becomes minimum. In addition, for example, the control unit 301 associates the value of the coefficient that has been obtained as a result of the regression analysis in S912, with the coefficient, and a related event corresponding to the coefficient, and stores the value, the coefficient, and the related event in the coefficient information 1200, and the operational flow ends.

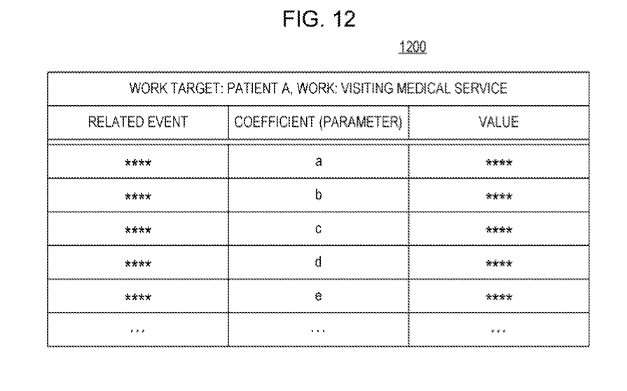

FIG. 12 is a diagram illustrating an example of the coefficient information 1200 according to the embodiment. The coefficient information 1200 is generated, for example, by the operational flow of FIG. 9, for a pair of the certain type of work and the certain work target that has been specified at the time of input of an execution instruction of the difference time analysis processing. The coefficient information 1200 includes, for example, “related event”, “coefficient (parameter)”, and “value”. The “related event” of the coefficient information 1200 includes a related event 102 associated with a coefficient of the entry, out of the related events 102 registered in the related event information 800. The “coefficient (parameter)” of the coefficient information 1200 is a coefficient (parameter) that has been assigned to the related event 102 through the regression analysis, and the “value” of the coefficient information 1200 is a value that has been obtained as a result of the regression analysis for the coefficient.

As described above, the control unit 301 may obtain a coefficient (parameter) of the regression analysis for each of the related events 102, through the operational flow of FIG. 9. For example, the obtained coefficient may be used to estimate service provision time of the certain type of work for the certain work target by the control unit 301. Note that by executing the operational flow of FIG. 9 for various types of work applied to various work targets, the respective coefficient information 1200 of the various types of work for the work targets may be obtained.

In the above-described operational flow of FIG. 9, the control unit 301 operates, for example, as the calculation unit 314.

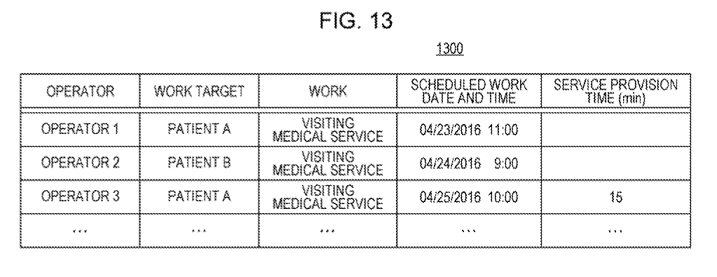

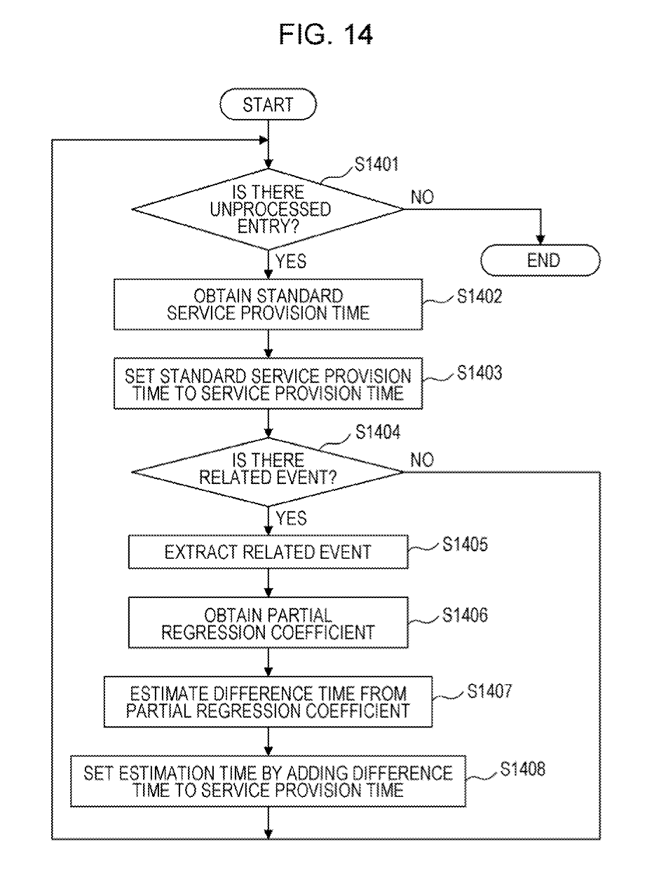

Processing for estimating service provision time is described next with reference to FIGS. 13 and 14. FIG. 13 is a diagram illustrating an example of the request information 1300 that includes information on work the operator is requested. For example, when a request of work is received, an entry related to the request may be registered in the request information 1300. The request information 1300 includes, for example, information such as “operator”, work target“, “work”, “scheduled work date and time”, and “service provision time”. Here, “operator” of the request information 1300 is, for example, information for identifying an operator who has been requested to perform work corresponding to the entry. In addition, “work target” of the request information 1300 is, for example, information for identifying a target for whom requested work is performed. In addition, “work” of the request information 1300 is information that indicates the requested work. In addition, “scheduled work date and time” of the request information 1300 is information indicating a scheduled date and time to perform the requested work. In addition, in “service provision time”, service provision time for the work corresponding to the entry, estimated by the processing of FIG. 14 described later is registered. A value does not have to be registered in the “service provision time” of the entry for which service provision time is yet to be estimated. In addition, the control unit 301 may estimate service provision time for the requested work registered in the request information 1300 by the service provision time estimation processing described later.

FIG. 14 is a diagram illustrating an example of the service provision time estimation processing in the embodiment. The control unit 301 may start the service provision time estimation processing of FIG. 14, for example, when an instruction to execute the service provision time estimation processing is input.

In S1401, for example, the control unit 301 determines whether or not there is an unprocessed entry in which service provision time is yet to be estimated in the request information 1300. When an unprocessed entry is registered in the request information 1300 (YES in S1401), one unprocessed entry is selected, and the flow proceeds to 1402.

In S1402, the control unit 301 obtains standard service provision time corresponding to a pair of a work target (hereinafter, referred to as a certain work target in the operational flow) and a specified type of work (hereinafter, referred to as a certain type of work in the operational flow) specified in the selected entry, from the standard service provision time information 600. In S1403, the control unit 301 sets the obtained standard service provision time to the “service provision time” of the selected entry. In S1404, the control unit 301 determines whether or not there is a related event 102 related to the certain type of work performed for the certain work target that has been specified in the selected entry. For example, the control unit 301 may determine whether or not a related event 102 has occurred for the certain work target in a time period between the performance of certain type of work that has been specified in the selected entry and the immediately preceding performance of the same type of work performed for the work target of the entry, with reference to the event information 400. Then, when a related event 102 has not occurred (NO in S1404), the flow returns to S1401. Conversely, when a related event 102 has occurred (YES in S1404), the flow proceeds to S1405.

In S1405, for example, the control unit 301 extracts a related event 102 related to the certain type of work performed for the certain work target that has been specified by the selected entry. For example, the control unit 301 may extract an event that has occurred in the certain work target, in a time period between the performance of certain type of work performed for the certain work target that has been specified in the selected entry and immediately preceding performance of the same type of work performed for the certain work target, from the event information 400, as the related event 102. In S1406, the control unit 301 obtains a partial regression coefficient corresponding to the extracted related event 102 and the value from the coefficient information 1200. Note that, for example, in another embodiment, in S1406, the control unit 301 may further extract only a related event 102 in which the coefficient is a certain threshold value or greater, and execute subsequent processing using the coefficient of the extracted related event 102.

In S1407, the control unit 301 estimates a difference time that is a deviation from the standard service provision time caused by the related events 102, for example, using the obtained coefficient and the value. For example, the control unit 301 may calculate the difference time by substituting the number of times of performance of each of the related events 102 that have been extracted in S1405 and the value of the coefficient that has been obtained in S1406 corresponding to the related event 102, into the equation of the regression analysis used in S912. Note that, in the equation of the regression analysis, for example, 0 may be substituted for a coefficient of a related event 102 that has not been extracted in S1405.

In S1408, the control unit 301 sets an estimated time that has been obtained by adding the difference time that had been estimated in S1407 to the service provision time that had been set in S1403, as “service provision time” of the entry that has been selected in the request information 1300, and the flow returns to S1401.

In the operational flow of FIG. 14, in the processing of S1404 to S1405, the control unit 301 may operate, for example, as the extraction unit 311. In the processing of S1403, and S1406 to S1408, the control unit 301 may operate, for example, as the estimation unit 312. In addition, in S1406, when processing is executed in which only a related event 102 in which the coefficient is the certain threshold value or greater is further extracted, the control unit 301 may operate as the extraction unit 311 in such extraction processing.

As described above, in the embodiment, the control unit 301 estimates service provision time of the certain type of work in the second performance, based on a related event 102 that has occurred in a time period from the first performance of the certain type of work for the certain work target to the second performance in which the certain type of work is performed next. Therefore, the control unit 301 is able to estimate the service provision time of the certain type of work at the time of the second performance considering influence of the related event 102 that has occurred in the time period from the first performance to the second performance of the certain type of work. This thereby enables the estimation accuracy of the service provision time to be improved.

Here, the related event 102 may be, for example, a further work other than the certain type of work that has been performed for the work target, and the control unit 301 is able to estimate service provision time considering the influence of the further work other than the certain type of work that has been performed for the work target at the time of estimation of the service provision time for the certain type of work.

In addition, in the embodiment, the control unit 301 obtains standard service provision time for the certain type of work from service provision time for the certain type of work related to which no event has occurred in a time period since the immediately preceding certain type of work performed for the work target, out of at least one certain type of work that has been performed for the work target. Therefore, standard service provision time for the certain type of work that is not affected by the related event 102 may be estimated.

In addition, the control unit 301 extracts a certain type of work related to which a related event 102 has occurred in the time period from the immediately preceding certain type of work performed, out of at least one certain type of work that has been performed for the work target. Then, the control unit 301 analyzes a relationship between, a difference time between service provision time of the extracted certain type of work and the standard service provision time, and the related event 102 related to the extracted certain type of work, so as to calculate a value of a coefficient (parameter) corresponding to the related event 102. This thereby enables the control unit 301 to estimate the service provision time of the certain type of work, according to the occurrence of the related event 102 using the coefficient (parameter), with high accuracy.

In addition, in the embodiment, the control unit 301 estimates service provision time using a related event 102 for which the value of the coefficient (parameter) is a certain threshold value or greater, out of related events 102 that has occurred in the time period from the immediately preceding certain type of work performed for the certain work target. This thereby enables, for example, calculation with respect to a related event 102 that has limited influence on the service provision time to be omitted.

As described above, the embodiment enables the accuracy of estimating service provision time to be improved.

In the above-described processing, an example is described in which calculation of a value of a coefficient for a related event 102 and estimation of service provision time using the value of the coefficient are performed in the estimation device 201. However, the embodiment is not limited thereto, and for example, a part of the above-described processing may be executed in a device other than the estimation device 201. For example, the processing up to the above-described calculation of the value of the coefficient associated with the related event 102 may be executed in another device.

The embodiments of the technology discussed herein are described above as examples, but the embodiments are not limited to such examples. For example, the above-described operational flow is only an example, and the embodiments are not limited to such an example. Where possible, the operational flow may be executed with the processing order changed, may include separate and further processing, or a part thereof may be omitted. For example, order of the processing of S701 and the processing of S702 of FIG. 7 may be reversed.

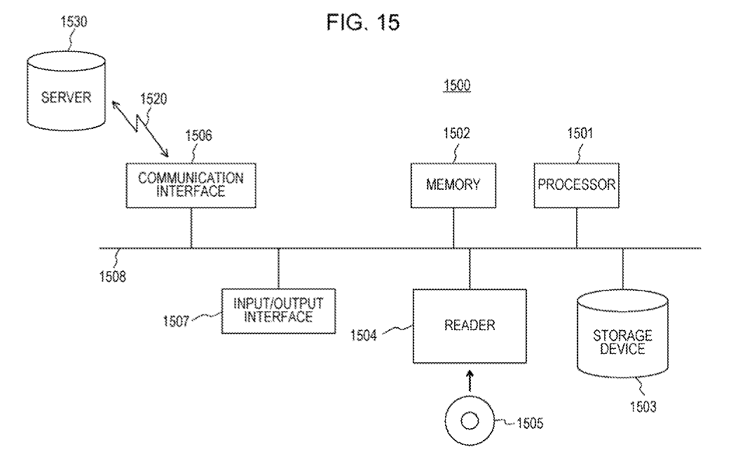

FIG. 15 is a diagram illustrating an example of a hardware configuration of a computer 1500 for implementing the estimation device 201 according to the embodiment. The hardware configuration for implementing the estimation device 201 of FIG. 15 includes, for example, a processor 1501, a memory 1502, a storage device 1503, a reader 1504, a communication interface 1506, and an input/output interface 1507. Note that the processor 1501, the memory 1502, the storage device 1503, the reader 1504, the communication interface 1506, and the input/output interface 1507 are coupled to each other, for example, through a bus 1508.

The processor 1501 provides all or a part of the function of the above-described control unit 301, for example, by executing a program in which a procedure of the above-described operational flow is described, using the memory 1502. For example, the processor 1501 operates as the extraction unit 311, the estimation unit 312, the obtaining unit 313, and the calculation unit 314, for example, by reading and executing the program stored in the storage device 1503. In addition, the storage unit 302 includes, for example, the memory 1502, the storage device 1503, and a removable storage medium 1505. The storage device 1503 of the estimation device 201 may store, for example, the event information 400, the standard service provision time information 600, the related event information 800, the related event difference time information 1000, the coefficient information 1200, and the request information 1300.

The memory 1502 is, for example, a semiconductor memory, and may include a RAM area and a ROM area. The storage device 1503 is, for example, a hard disk, a semiconductor memory such as a flash memory, or an external storage device. “RAM” is an abbreviation of a random access memory. In addition, “ROM” is an abbreviation of a read only memory.

The reader 1504 accesses the removable storage medium 1505 in accordance with an instruction of the processor 1501. The removable storage medium 1505 is implemented, for example, by a semiconductor device (USB memory or the like), a medium for input and output of information magnetically (magnetic disk or the like), a medium for input and output of information optically (CD-ROM, DVD, and the like), or the like. “USB” is an abbreviation of a universal serial bus. “CD” is an abbreviation of a compact disc. “DVD” is an abbreviation of a digital versatile disk.

The communication interface 1506 transmits and receives data through a network 1520 in accordance with an instruction of the processor 1501. The input/output interface 1507 may be, for example, an interface between an input device and an output device. The input device may be, for example, a device that accepts an instruction from the user such as a keyboard and a mouse. The output device may be, for example, a display device such as a display and an audio device such as a speaker.

Each program according to the embodiment is provided to the estimation device 201, for example, in the following forms.

(1) The program is pre-installed into the storage device 1503.

(2) The program is provided through the removable storage medium 1505.

(3) The program is provided from a server 1530 such as a program server.

The hardware configuration of the computer 1500 for implementing the estimation device 201 described above with reference to FIG. 15 is an example, and the embodiments are not limited to such an example. For example, some or all of functions of the above-described function units may be implemented as hardware in the form of a FPGA, a SoC, and the like. “FPGA” is an abbreviation of a field programmable gate array. “SoC” is an abbreviation of a system on chip.

The embodiments of the technology discussed herein are described above. However, it ought to be understood that the technology discussed herein is not limited to the above-describe embodiments and includes various modifications and alternatives of the above-described embodiments. For example, it will be understood that various embodiments can be made by modifying the configuration elements without departing from the spirit and scope thereof. In addition, it will be understood that various embodiments can be made by combining the plurality of configuration elements disclosed in the above-described embodiments as appropriate. In addition, those skilled in the art will appreciate that various embodiments may be implemented by deleting or replacing some of the configuration elements from the configuration elements all described in the embodiments, or adding some configuration elements to the configuration elements described in the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An estimation device comprising:
a memory; and
a processor coupled to the memory and configured to execute a process including,
associating a plurality of events that occurs with respect to a work target, which includes at least one session of specific work performed for the work target, with a date and times in which the plurality of events respectively occurred,
storing the associated plurality of events and the date and times in the memory,
extracting at least one event that occurs with respect to the work target in a time period from first performance of the specific work to second performance in which the specific work is performed after the first performance, from the plurality of events, and
estimating service provision time of the specific work at the time of the second performance, based on the at least one event.

2. The estimation device according to claim 1, wherein
in the storing, service provision time of the at least one session of the specific work performed for the work target is further stored,
the estimating further includes
obtaining standard service provision time of the specific work from service provision time of a session of the specific work in relation to which an event has not occurred in a time period from the immediately preceding session of the specific work performed previously, out of the at least one session of the specific work,
analyzing a relationship between a difference time obtained by calculating a difference between the standard service provision time and service provision time of a session of the specific work in relation to which a related event has occurred in the time period from the immediately preceding session of the specific work out of the at least one session of the specific work, and the related event, and
calculating a value of a parameter corresponding to the related event, and
the service provision time at the time of the second performance of the specific work is estimated using a value of the parameter corresponding to the at least one event out of values of parameters corresponding to related events.

3. The estimation device according to claim 2, wherein
in the extracting, an event in which the value of the parameter is a specific threshold value or greater is extracted as the at least one event out of events that have occurred for the work target in the time period from the first performance to the second performance.

4. A computer-readable and non-transitory storage medium storing an estimation program causing a computer to execute a process, the process comprising:
extracting at least one event that occurs with respect to a work target in a time period from first performance of specific work to second performance of the specific work performed after the first performance, out of a plurality of events which includes at least one session of the specific work performed for the work target, stored in a storage unit that associates the plurality of events with date and times in which the plurality of events occurred respectively; and
estimating service provision time of the specific work at the time of the second performance, based on the at least one event.

5. An estimation method causing a computer to execute a process, the process comprising:
extracting at least one event that occurs with respect to a work target in a time period from first performance of specific work to second performance of the specific work performed after the first performance, out of the plurality of events which includes at least one session of the specific work performed for the work target, stored in a storage unit that associates the plurality of events with date and times in which the plurality of events occurred respectively; and
estimating service provision time of the specific work at the time of the second performance, based on the at least one event.
